(19) United States
(12) Patent Application Publication
(10) Pub. No.: US 2017/0146921 A1
(43) Pub. Date: May 25, 2017

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Tomomi Suzuki, Mishima Shizuoka (JP)

(21) Appl. No.: 15/219,541

(22) Filed: Jul. 26, 2016

(30) Foreign Application Priority Data
Nov. 24, 2015 (JP) 2015-228747

(51) Int. Cl. G03G 15/00

(52) U.S. Cl. CPC G03G 15/01; B41M 5/30

(57) ABSTRACT

An image forming apparatus comprises a sensor configured to detect on a sheet an image with a decolorable recording agent containing a coloring material to be decolored from the sheet; a printer configured to carry out a printing operation of an image formed with the decolorable recording agent and a printing operation of an image formed with a non-decolorable recording agent containing a coloring material that is not decolored; and a controller configured to control the printer to execute the printing operation with the decolorable recording agent on the sheet in a case in which the image is detected by the sensor.

### CROSS-REFERENCE TO RELATED APPLICATION

This application is based upon and claims the benefit of priority from Japanese Patent Application No. 2015-228747, filed Nov. 24, 2015, the entire contents of which are incorporated herein by reference.

### FIELD

Embodiments described herein relate generally to an image forming apparatus.

### BACKGROUND

Conventionally, there is known an image forming apparatus capable of executing a decoloring operation on a sheet printed with a recording agent (hereinafter, referred to as a “decolorable recording agent”) containing a coloring material to be decolored. For example, the image forming apparatus is an MFP (Multi-Function Peripheral) and the like. The sheet decolored by the image forming apparatus with such a decoloring function can be reused. As the decolorable recording agent is blue, it is easy to distinguish the sheet printed with the decolorable recording agent from a sheet printed with a recording agent (hereinafter referred to as a “non-decolorable recording agent”) containing a coloring material that is not decolored.

However, in a case in which the decolorable recording agent has the same color as the non-decolorable recording agent, it is difficult to determine if the sheet is printed with a decolorable or a non-decolorable recording agent. In this case, if a printing operation on a back surface of the sheet printed with the decolorable recording agent is carried out with the use of the non-decolorable recording agent, there is a possibility that a reuse rate of the sheet is lowered.

### DESCRIPTION OF THE DRAWINGS

FIG. 1 is an external view illustrating an example of the whole configuration of an image forming apparatus 1 according to an embodiment;

FIG. 2 is a block diagram schematically illustrating the configuration of functional blocks of the image forming apparatus 1;

FIG. 3 is a diagram illustrating a concrete example of a sheet S after a printing with a decoloring toner is carried out thereto;

FIG. 4 is a flowchart illustrating the flow of a processing by the image forming apparatus 1;

FIG. 5 is a flowchart illustrating the flow of a processing by the image forming apparatus 1; and

FIG. 6 is a flowchart illustrating the flow of a processing by an image forming apparatus 1 according to a modification.

### DETAILED DESCRIPTION

In accordance with an embodiment, an image forming apparatus includes a sensor, a printer and a controller. The sensor is used to detect on a sheet an image with a decolorable recording agent comprising a coloring material to be decolored from the sheet. The printer carries out a printing operation an image formed with the decolorable recording agent and a printing operation of an image formed with a non-decolorable recording agent comprising a coloring material that is not decolored. In a case in which the image is detected by the sensor, the controller controls the printer to execute the printing operation with the decolorable recording agent on the sheet.

In accordance with another embodiment, an image forming method involves detecting on a sheet an image with a decolorable recording agent comprising a coloring material to be decolored from the sheet; carrying out a printing operation of an image formed with the decolorable recording agent and a printing operation of an image formed with a non-decolorable recording agent comprising a coloring material that is not decolored; and controlling execution of the printing operation with the decolorable recording agent on the sheet in a case in which the image is detected. Hereinafter, the image forming apparatus according to the embodiment is described with reference to the accompanying drawings.

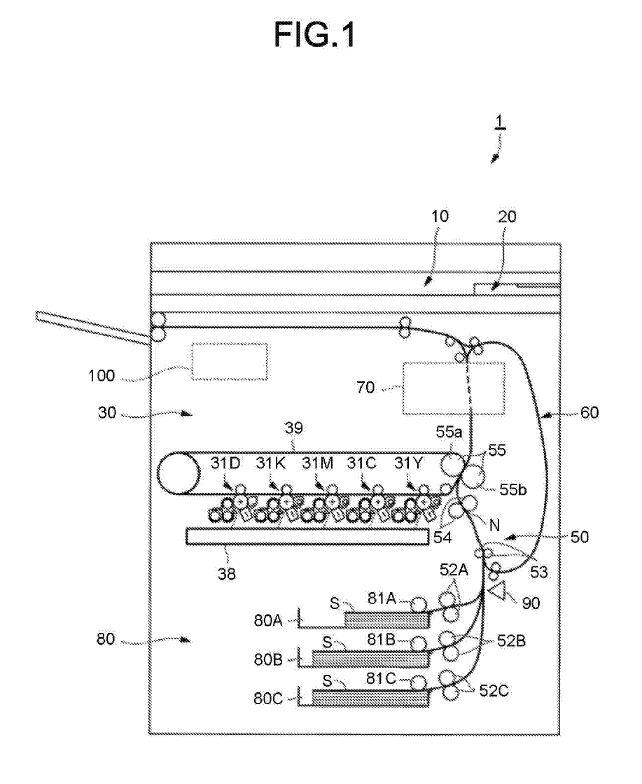

FIG. 1 is an external view illustrating an example of the whole configuration of an image forming apparatus 1 according to the embodiment.

The image forming apparatus 1 may be an MFP (Multi-Function Peripheral) capable of forming a toner image on a sheet S. The sheet S is, for example, an original document or a paper on which a character or an image is recorded. The sheet S may be any object as long as it can be read by the image forming apparatus 1. The image forming apparatus 1 reads an image shown on the sheet S and generates digital data to generate an image file.

The image forming apparatus 1 is equipped with an image reading section 10, a control panel 20, a printer 30, a sheet housing section 80, a sensor 90 and a controller 100. Further, the printer 30 of the image forming apparatus 1 may be a device which enables a toner image to be fixed, or an inkjet type device. In the present embodiment, a case in which the printer 30 is a device which enables a toner image to be fixed is described.

The image reading section 10 reads image information serving as a reading object as intensity of the light. The image reading section 10 records the read image information. The recorded image information may be sent to other information processing apparatuses via a network. The recorded image information may be used to form an image on the sheet S by the printer section 30.

The control panel 20 is equipped with a display section and an operation section. The display section is a liquid crystal display, an organic EL (Electro Luminescence) display or the like. The display section displays various kinds of information relating to the image forming apparatus 1 and its operations. The operation section is equipped with a plurality of buttons. The operation section is used to receive an operation by a user. The operation section outputs a signal corresponding to an operation executed by the user to the controller of the image forming apparatus 1. Furthermore, the display section and the operation section may be constituted as an integrated touch panel.

The printer 30 forms an image on a surface of the sheet S based on the image data generated by the image reading section 10. The printer 30 may form an image on the surface of the sheet S based on the image data sent by other information processing apparatuses via the network. The printer 30, for example, forms the image on the surface of the sheet S with toner. In the present embodiment, the toner contains toner of a decolorable recording agent (hereinafter referred to as “decoloring toner”) and toner of a non-decolorable recording agent (hereinafter, referred to as “normal toner”). The normal toner is, for example, yellow (Y) toner, magenta (M) toner, cyan (C) toner and/or black (K) toner. The decoloring toner is colored toner, which is identical to the normal toner, and is, for example, black toner. The decoloring toner is decolored at a temperature higher than a temperature at which the normal toner is fixed on the sheet S. Herein, the decoloring refers to a process of erasing an image formed with a color (containing not only chromatic colors but also achromatic colors such as white and/or black) different with that of a background of the sheet S so that the image cannot be visually seen after decoloring. Furthermore, the decoloring may be carried out with a method other than the decoloring by heating, such as irradiation or chemical treatment.

The sheet housing section 80 is equipped with a plurality of sheet feed cassettes 80A, 80B and 80C. The sheet feed cassettes 80A, 80B and 80C house sheets S with predetermined sizes and types. In the present embodiment, the sheet feed cassettes 80A, 80B and 80C are set as follows. The sheet feed cassette 80A houses a new sheet S. Herein, the new sheet S refers to a sheet S that is never previously used in printing. The sheet feed cassette 80B houses a sheet S that is decolored. The sheet feed cassette 80C houses the sheet S used as a backing sheet. Further, the setting of the sheet feed cassettes 80A, 80B and 80C may be changed as desired. In the following description, the sheet feed cassette 80A is recorded as the normal sheet feed cassette, and the sheet feed cassettes 80B and 80C are recorded as reuse sheet feed cassettes. The sheet feed cassettes 80A, 80B and 80C each are equipped with pickup rollers 81A, 81B and 81C. Each of the pickup rollers 81A, 81B and 81C takes out the sheets S one by one from each of the sheet feed cassettes 80A, 80B and 80C correspondingly. The pickup rollers 81A, 81B and 81C supply the sheet S taken out to a conveyance section 50.

The conveyance section 50 conveys the sheet S to the printer 30 and the sheet housing section 80. The conveyance section 50 is equipped with a sheet feed roller 52A, a sheet feed roller 52B, a sheet feed roller 52C, a conveyance roller 53, and a resist roller 54. The sheet feed rollers 52A, 52B and 52C conveys the sheets S supplied by the pickup rollers 81A, 81B and 810 to a resist roller 54. The resist roller 54 conveys the sheet S to a transfer section 55 side corresponding to the timing when the transfer section 55 of the printer 30 described later transfers a toner image onto the surface of the sheet S. The resist roller 54 conveys the sheet S to the transfer section 55 side after a front end of the sheet S sent by the conveyance roller 53 is aligned at a nip N.

The sensor 90 is arranged at a position where a predetermined area on the sheet S can be read. The sensor 90 detects a predetermined mark (image) printed in the predetermined area on the sheet S. Herein, the predetermined mark refers to a mark indicating that a printing operation with the decoloring toner is carried out on the sheet S. Hereinafter, a predetermined mark is recorded as a print mark. In a case in which the print mark exists in the predetermined area, the sensor 90 determines that the print mark is detected. On the other hand, in a case in which the print mark does not exist in the predetermined area, the sensor 90 determines that the print mark is not detected. The sensor 90 outputs a detection result to the controller 100 regularly or at a preset timing.

The controller 100 controls each functional section of the image forming apparatus 1. The detailed description of the controller 100 is described later.

Next, the configuration of the printer 30 is described in detail. The printer 30 is equipped with a developing section 31, an exposure section 38, an intermediate transfer belt 39, the transfer section 55, a reversing unit 60 and a fixing section 70. In the present embodiment, the number of the developing sections 31 corresponds to that of the handled toner.

Hereinafter, a developing section corresponding to the yellow (Y) toner is recorded as a developing section 31Y, and a developing section corresponding to the magenta (M) toner is recorded as a developing section 31M. A developing section corresponding to the cyan (C) toner is recorded as a developing section 31C, and a developing section corresponding to the black (K) toner is recorded as a developing section 31K. A developing section corresponding to the decolorable toner is recorded as a developing section 31D.

Each developing section 31 (31Y, 31M, 31C, 31K and 31D) supplies a developing agent housed in a developing agent housing section to a photoconductive drum. The developing agent housing section is a container for housing the developing agent. The developing agent is a mixture composed of a carrier made of magnetic fine particles and each toner. If the developing agent is stirred, the toner is frictionally charged. In this way, the toner adheres to the surface of the carrier by the electrostatic force. A first mixer, a second mixer, a developing roller and a temperature and humidity sensor are arranged inside the developing agent housing section. The first mixer and the second mixer stir the developing agent. The first mixer and the second mixer convey the developing agent. The second mixer is arranged below the developing roller. The second mixer supplies the developing agent housed in the developing agent housing section to the surface of the developing roller. The temperature and humidity sensor detects temperature and humidity of the inside of the developing agent housing section as the state of the printer 30.

The developing roller rotates counterclockwise through the drive of a developing motor. The developing roller is constituted by a magnetic body (magnet) in which negative electrodes and positive electrodes are alternately arranged along a circumference. The developing agent supplied by the second mixer is napped in a brush shape on the surface of the developing roller depending on magnetic field distribution of the developing roller. The napped developing agent contacts the photoconductive drum to sweep the surface thereof along with the rotation of the developing roller. Further, the magnetic field distribution of the developing roller can be switched. The developing section 31, through the switching of the magnetic field distribution of the developing roller, carries out the napping and ear cutting of the developing agent. The developing roller is connected with a voltage applying circuit. The voltage applying circuit receives the control of the controller 100 to apply a voltage to the developing roller as a developing bias. The voltage applied to the developing roller is, for example, negative direct current voltage.

The photoconductive drum has a photoconductive layer on the surface thereof. The photoconductive drum rotates clockwise through the drive of a developing motor. The developing section 31, a charging section, a charge removing section, a cleaning unit and a transfer roller are arranged around the photoconductive drum.

The charging section uniformly charges the surface (photoconductive layer) of the photoconductive drum. For example, the charging section charges the surface (photoconductive layer) of the photoconductive drum to negative polarity. In this way, the toner image is formed according to an electrostatic latent image on the surface (photoconductive layer) of the photoconductive drum.

For example, the developing section 31Y develops the electrostatic latent image on the surface (photoconductive layer) of the photoconductive drum with the yellow (Y) toner. The developing section 31M develops the electrostatic latent image on the surface (photoconductive layer) of the photoconductive drum with the magenta (M) toner. The developing section 31C develops the electrostatic latent image on the surface (photoconductive layer) of the photoconductive drum with the cyan (C) toner. The developing section 31K develops the electrostatic latent image on the surface (photoconductive layer) of the photoconductive drum with the black (K) toner. The developing section 31D develops the electrostatic latent image on the surface (photoconductive layer) of the photoconductive drum with the decolorable toner.

The cleaning unit scrapes the surface of the photoconductive drum to remove the non-transferred toner left thereon. The cleaning unit removes the toner left on the surface of the photoconductive drum after the toner image is transferred from the photoconductive drum onto the intermediate transfer belt 39. The toner removed by the cleaning unit is collected in an abandon toner tank to be abandoned.

The charge removing section faces the photoconductive drum passing through the cleaning unit. The charge removing section emits the light to the surface of the photoconductive drum. In this way, non-uniform charge of the photoconductive layer becomes uniform. In other words, the charge of the photoconductive layer is removed.

The transfer roller faces the photoconductive drum across the intermediate transfer belt 39. The transfer roller abuts against the surface of the photoconductive drum across the intermediate transfer belt 39. The transfer roller transfers (primarily transfers) the toner image on the surface of the photoconductive drum onto the intermediate transfer belt 39.

The exposure section 38 is arranged at a position facing the photoconductive drum of each of the developing sections 31Y, 31M, 31C, 31K and 31D. The exposure section 38 irradiates the surface (photoconductive layer) of the photoconductive drum of each of the developing sections 31Y, 31M, 31C, 31K and 31D with laser light. The light emission by the exposure section 38 is controlled by the controller 100 based on the image data. The exposure section 38 emits the laser light based on the image data. In this way, the negative charges on the surface (photoconductive layer) of the photoconductive drum of each of the developing sections 31Y, 31M, 31C, 31K and 31D disappear.

As a result, a pattern of static electricity is formed at a position where the laser light is emitted on the surface (photoconductive layer) of the photoconductive drum. In other words, through the irradiation of the laser light by the exposure section 38, the electrostatic latent image is formed on the surface (photoconductive layer) of the photoconductive drum. Furthermore, the exposure section 38 may use LED (Light Emitting Diode) light instead of the laser light.

The reversing unit 60 reveres the sheet S discharged from the fixing section 70 through switchback. The reversing unit 60 conveys the reversed sheet S to the front of the resist roller 54 again. The reversing unit 60 reverses the sheet S in order to form the toner image on a back surface of the sheet S to which the fixing process is carried out.

The fixing section 70 applies heat and pressure to the sheet S. The fixing section 70 fixes the toner image transferred onto the sheet S through the heat and pressure.

Hereinafter, as print categories, a case in which printing is carried out with the normal toner is recorded as normal printing, and a case in which printing is carried out with the decoloring toner is recorded as eco-printing.

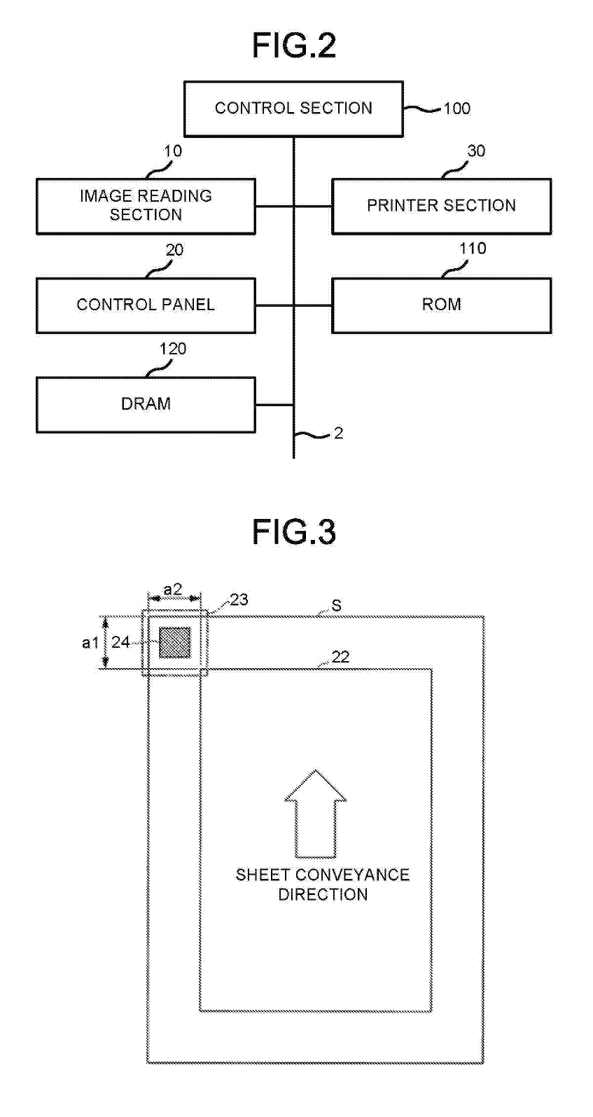

FIG. 2 is a block diagram schematically illustrating the configuration of functional blocks of the image forming apparatus 1.

The description of the image reading section 10, the control panel 20 and the printer 30 shown in FIG. 2 is the same as the description stated above, and thus is omitted. Hereinafter, the controller 100, a ROM (Read Only Memory) 110 and a DRAM (Dynamic Random Access Memory) 120 are described. Further, the functional sections are connected in a communicable manner via a system bus line 2.

The controller 100 controls each functional section connected via the system bus line 2. Hereinafter, the concrete processing by the controller 100 is described. The controller 100 controls the pickup roller 81 to convey the sheet S from the sheet feed cassette 80 corresponding to an instruction from a user. The controller 100, in a case in which the printing with the decoloring toner is carried out, controls the printer 30 to print a print mark on the sheet S. The print mark may be any mark as long as it can be read by the sensor 90. The controller 100 controls the toner to be used in the printing depending on the detection result of the sensor 90. For example, the controller 100 controls, in a case in which the print mark is detected by the sensor 90, the printer 30 to execute the printing operation on the sheet S with the decoloring toner. Contrarily, the controller 100 controls, in a case in which the print mark is not detected by the sensor 90, the printer 30 to execute the printing operation on the sheet S with the normal toner. Further, in a case in which the feed source of the sheet is the normal sheet feed cassette, the controller 100 carries out the printing with the toner corresponding to the print category selected by the user regardless of the detection result from the sensor 90.

A ROM 110 stores various control programs necessary for the controller 100 to operate.

A DRAM 120 is used as a temporary storage area of data at the time the controller 100 executes a program.

FIG. 3 is a diagram illustrating a concrete example of a sheet S after the printing with the decoloring toner is carried out thereto. An image forming area 22 located at the interior of the sheet S indicates a domain where an image relating to actual data is formed with the decoloring toner or the normal toner. In a case in which the execution of the printing is instructed from the user, the image forming apparatus 1 forms the image relating to the actual data in the image forming area 22. Further, the image forming apparatus 1 may form the image at the outside of the image forming area 22. Thus, the image relating to the header or footer at the outside of the image forming area 22 may be formed.

In the example shown in FIG. 3, a print mark 24 is formed inside a detection target area 23 arranged at the outside of the image forming area 22. In the example shown in FIG. 3, one detection target area 23 is defined as an area surrounded by a front end side, a left side of the conveyance direction of the sheet S, a first inner side and a second inner side. The front end side is located at the front end of the conveyance direction of the sheet S. The first inner side is located at a position away from the front end side by a length a1 and parallel to the front end side. The second inner side is located at a position away from the left side of the conveyance direction of the sheet S by a length a2 and parallel to the left side. The print mark 24 is printed at the time the printing with the decoloring toner is carried out. The print mark 24 may be printed with the decoloring toner, the normal toner or other ink.

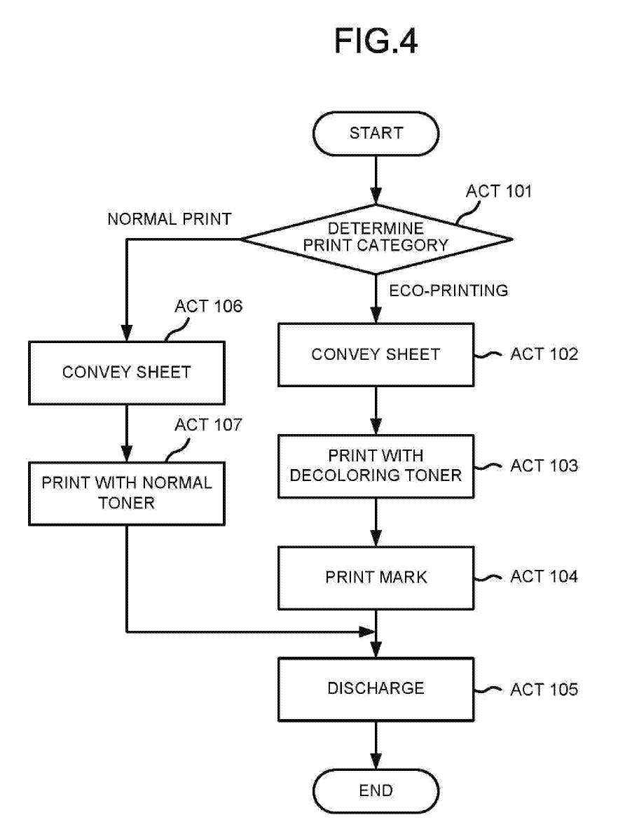

FIG. 4 is a flowchart illustrating the flow of a processing by the image forming apparatus 1. Further, in FIG. 4, a case in which the printing is executed on the sheet S housed in the normal sheet feed cassette is described.

The controller 100 determines, if it is determined that there is the printing instruction from the user, the print category selected by the user (ACT 101). If it is determined that the print category selected by the user is the eco-printing (ACT 101: eco-printing), the controller 100 enables the sheet S to be conveyed from the normal sheet feed cassette (ACT 102). The controller 100 controls the printer section 30 to execute the printing with the decoloring toner on the sheet S (ACT 103). The controller 100 controls the printer 30 to print the print mark at the predetermined position of the sheet S (ACT 104). Afterwards, the controller 100 controls the conveyance section 50 to discharge the sheet S to which the printing is carried out (ACT 105).

On the other hand, if it is determined that the print category selected by the user is the normal printing (ACT 101: normal printing), the controller 100 enables the sheet S to be conveyed from the normal sheet feed cassette (ACT 106). The controller 100 controls the printer 30 to execute the printing with the normal toner on the sheet S (ACT 107).

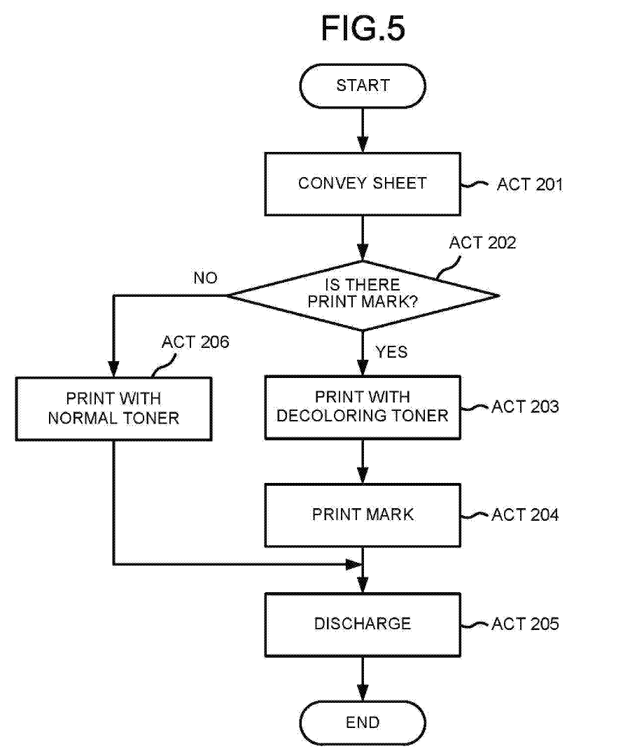

FIG. 5 is a flowchart illustrating the flow of a processing by the image forming apparatus 1. Further, in FIG. 5, a case in which the printing is executed on the sheet S housed in the reuse sheet feed cassette is described.

The controller 100 enables the sheet S to be conveyed from the reuse sheet feed cassette (ACT 201). Afterwards, the controller 100 determines whether or not there is the print mark on the sheet S conveyed from the reuse sheet feed cassette (ACT 202). The determination relating to whether or not there is the print mark is executed based on the detection result from the sensor 90. Specifically, in a case in which the detection result from the sensor 90 indicates that there is a mark, the controller 100 determines that there is the print mark on the sheet S conveyed from the reuse sheet feed cassette. On the other hand, in a case in which the detection result from the sensor 90 indicates that there is no mark, the controller 100 determines that there is no print mark on the sheet S conveyed from the reuse sheet feed cassette.

If it is determined that there is the print mark (ACT 202: YES), the controller 100 controls the printer 30 to execute the printing with the decoloring toner on the sheet S (ACT 203). The controller 100 controls the printer 30 to print the print mark at the predetermined position of the sheet S (ACT 204). Then, the controller 100 controls the conveyance section 50 to discharge the sheet S to which the printing is carried out (ACT 205).

If it is determined that there is no print mark in ACT 202 (ACT 202: NO), the controller 100 controls the printer 30 to execute the printing with the normal toner on the sheet S (ACT 206). Then, the controller 100 controls the conveyance section 50 to discharge the sheet S to which the printing is carried out (ACT 205).

According to the image forming apparatus 1 with the foregoing configuration, the reuse rate of the sheet can be improved. Hereinafter, the effect is described in detail.

In a case in which the printing (first printing) with the normal toner is carried out on the sheet S housed in the normal sheet feed cassette, the image forming apparatus 1 does not print the print mark on the sheet S. Thus, in a case in which the printing (second printing) is carried out on an opposite surface of the same sheet S, the image forming apparatus 1 does not acquire the detection result indicating that the mark is detected by the sensor 90. Thus, the image forming apparatus 1 executes the second printing with the normal toner. On the other hand, in a case in which the printing (first printing) with the decoloring toner is carried out on the sheet S housed in the normal sheet feed cassette, the image forming apparatus 1 prints the print mark on the sheet S. Thus, in a case in which the printing (second printing) is carried out on the opposite side of the same sheet S, the image forming apparatus 1 acquires the detection result indicating that the mark is detected by the sensor 90. Thus, the image forming apparatus 1 carries out the second printing with the decoloring toner. In this way, a case in which the image forming apparatus 1 carries out the printing with the decoloring toner on the opposite side of the sheet S on which the printing with the normal toner is carried out does not occur. A case in which the image forming apparatus 1 carries out the printing with the normal toner on the opposite side of the sheet S on which the printing with the decoloring toner is carried out does not occur yet. Thus, the image forming apparatus 1 can prevent the mixture of the normal toner and the decoloring toner on one sheet S. Therefore, the successful reuse rate of the sheet can be improved.

In a case in which the printing with the decoloring toner is carried out, the image forming apparatus 1 prints the print mark in the predetermined area of the sheet S. In this way, the image forming apparatus 1 can determine that the sheet S is printed with the decoloring toner in a case in which the same sheet S is used in the printing operation from next time. As a result, the image forming apparatus 1 carries out the printing with the decoloring toner again to improve the successful reuse rate of the sheet.

Hereinafter, the modification of the image forming apparatus 1 is described.

The sensor 90 may be arranged for each cassette 80 or arranged for only a specific cassette (for example, the reuse sheet feed cassette).

The position where the print mark 24 is printed is not limited to the position shown in FIG. 3, and may be any position as long as it can be read by the sensor 90.

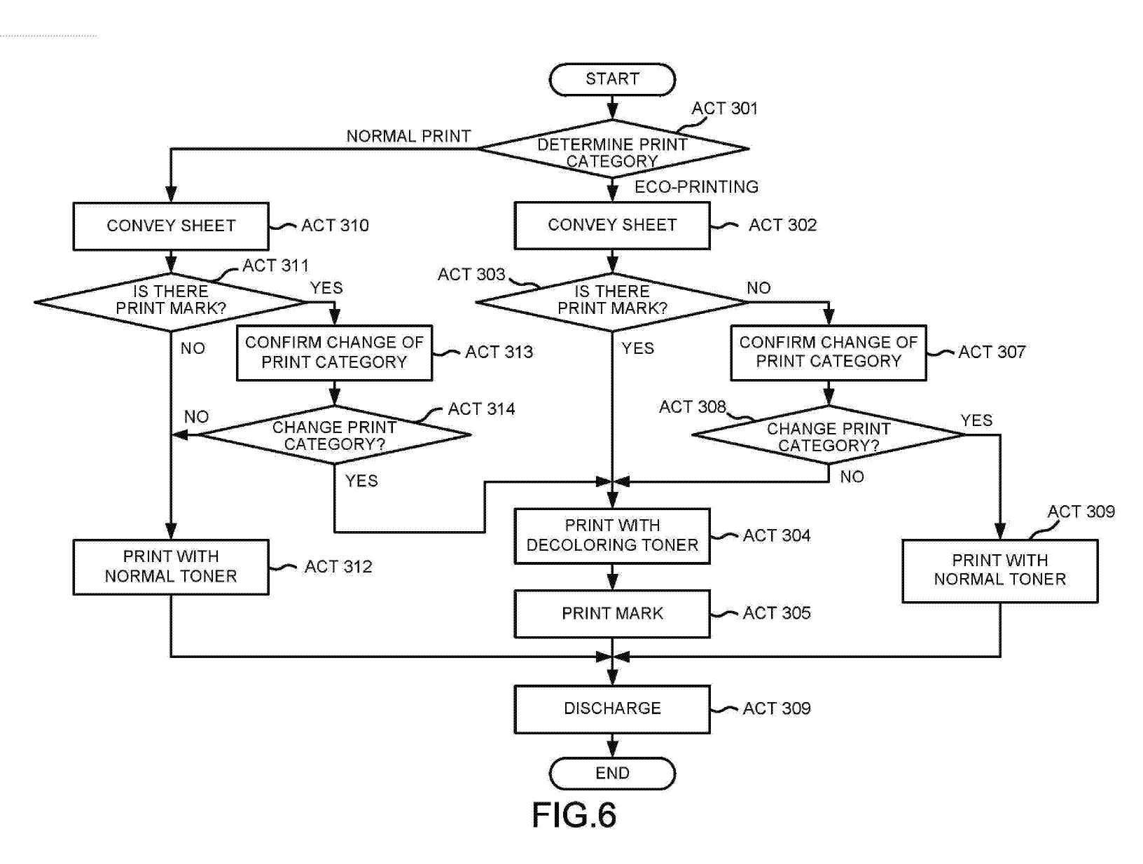

In the present embodiment, according to the toner used in the first printing, a configuration in which the toner used in the case of executing the second printing on the same sheet S is automatically selected is described. However, in the case of executing the second printing on the same sheet S, the processing by the image forming apparatus 1 is not limited to that. For example, the image forming apparatus 1 may be constituted in such a manner that an intention confirmation about the toner used in the printing may be carried out for the user who executes the printing. The flow of the specific processing is described with reference to FIG. 6.

FIG. 6 is a flowchart illustrating the flow of a processing by an image forming apparatus 1 according to the modification. Further, in FIG. 6, a case in which the printing is carried out on the sheet S housed in the reuse sheet feed cassette is described.

If it is determined that there is the printing instruction from the user, the controller 100 determines the print category selected by the user (ACT 301). If it is determined that the print category selected by the user is the eco-printing (ACT 301: eco-printing), the controller 100 enables the sheet S to be conveyed from the reuse sheet feed cassette (ACT 302). Then, the controller 100 determines whether or not there is the print mark on the sheet S conveyed from the reuse sheet feed cassette (ACT 303). If it is determined that there is the print mark (ACT 303: YES), the controller 100 controls the printer 30 to execute the printing with the decoloring toner on the sheet S (ACT 304). The controller 100 controls the printer 30 to print the print mark at the predetermined position of the sheet S (ACT 305). Then, the controller 100 controls the conveyance section 50 to discharge the sheet S to which the printing is carried out (ACT 306).

In ACT 303, if it is determined that there is no print mark (ACT 303: NO), the controller 100 carries out confirmation on the change of the print category for the user (ACT 307). Specifically, the controller 100 enables the display section to display a display for urging to carry out the printing with the print category different from the print category selected by the user. For example, the controller 100 enables the display section to display a display for urging to carry out the eco-printing. Further, the controller 100 does not execute the printing during the period the display is executed. In other words, the controller 100 stops the conveyance of the sheet S en route. Then, the controller 100 restarts the printing in a case in which an instruction for the display is input from the user. In other words, the controller 100 controls the conveyance section 50 to convey the sheet S. The controller 100 determines whether or not the change of the print category is instructed (ACT 308). If it is determined that the change of the print category is instructed (ACT 308: YES), the controller 100 controls the printer 30 to execute the printing with the normal toner on the sheet S (ACT 309). In this case, the controller 100 controls the printer 30 to execute the normal printing from the eco-printing.

On the other hand, if it is determined that the change of the print category is not instructed (ACT 308: NO), the image forming apparatus 1 executes the processing subsequent to the processing in ACT 304 in the same way as stated above.

In the processing in ACT 301, if it is determined that the print category is the normal printing (ACT 301: normal printing), the controller 100 enables the sheet S to be conveyed from the reuse sheet feed cassette (ACT 310).

Then, the controller 100 determines whether or not there is the print mark on the sheet S conveyed from the reuse sheet feed cassette (ACT 311). If it is determined that there is no print mark (ACT 311: NO), the controller 100 controls the printer 30 to execute the printing with the normal toner on the sheet S (ACT 312).

On the other hand, if it is determined that there is the print mark (ACT 311: YES), the controller 100 carries out confirmation on the change of the print category for the user (ACT 313). Specifically, the controller 100 enables the display section to display a display for urging to carryout the printing with the print category different from the print category selected by the user. For example, the controller 100 enables the display section to display a display for urging to carry out or prompting the normal printing. Further, the controller 100 does not execute the printing during the period the display is executed. In other words, the controller 100 stops the conveyance of the sheet S en route. Then, the controller 100 restarts the printing in a case in which an instruction for the display is input from the user. In other words, the controller 100 controls the conveyance section 50 to convey the sheet S. The controller 100 determines whether or not the change of the print category is instructed (ACT 314). If it is determined that the change of the print category is instructed (ACT 314: YES), the controller 100 executes the processing subsequent to the processing in act 304 in the same way as stated above. In this case, the controller 100 controls the printer 30 to execute the eco-printing from the normal printing.

On the other hand, if it is determined that the change of the print category is not instructed (ACT 314: NO), the controller 100 controls the printer 30 to execute the printing with the normal toner on the sheet S (ACT 312).

Through the foregoing configuration, the printing with the toner that is not wanted by the user is not carried out. In this way, the image forming apparatus 1 can change the proper print category according to the instruction by the user to execute the printing. Thus, the convenience of the image forming apparatus 1 can be improved.

A display for urging to carry out the printing with the print category different from the print category selected by the user may be displayed on the display section of a communication device operated by the user. The communication device is, for example, an information processing apparatus such as a personal computer or a smart phone.

According to at least one embodiment described above, by including the sensor 90 for detecting the print mark from the sheet S, the printer 30 for carrying out the printing with the decoloring toner or the normal toner and the controller 100 which controls the printer 30 to carry out the printing with the decoloring toner on the sheet S in a case in which the print mark is detected by the sensor 90, the reuse rate of the sheet can be improved.

A part of the functions of the image forming apparatus 1 according to the foregoing embodiments may be realized by a computer. In this case, programs for realizing the functions are recorded in a computer-readable recording medium. The programs recorded in the recording medium in which the foregoing programs are recorded may be read into a computer system and executed to be realized. Further, it is assumed that the “computer system” described herein contains an operating system or hardware such as peripheral devices. Further, the “computer-readable recording medium” refers to a portable medium or a storage device. The portable medium is a flexible disc, a magneto-optical disk, a ROM, a CD-ROM and the like. The storage device is a hard disk built in the computer system.

Furthermore, the “computer-readable recording medium” refers to a non-transitory medium for dynamically holding the programs for a short time like a communication wire in a case in which the programs are sent via a communication line. The communication line is a network such as the Internet or a telephone line. The “computer-readable recording medium” may be a volatile memory in the computer system serving as a server and a client. The volatile memory holds the programs for a certain time. The foregoing programs may realize a part of the above-mentioned functions. Further, the foregoing programs may be realized by the combination of the above-mentioned functions with the programs already recorded in the computer system.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a sensor configured to detect on a sheet an image with a decolorable recording agent comprising a coloring material;
a printer configured to carry out a printing operation of an image formed with the decolorable recording agent and a printing operation of an image formed with a non-decolorable recording agent comprising a coloring material; and
a controller configured to control the printer to execute the printing operation with the decolorable recording agent on the sheet in a case in which the image formed with the non-decolorable recording agent or decolorable recording agent is detected by the sensor.

2. The image forming apparatus according to claim 1, wherein
the printer prints the image in a predetermined area of the sheet in a case in which the printing with the decolorable recording agent is carried out.

3. The image forming apparatus according to claim 1, wherein
the controller controls the printer to carry out the printing with the non-decolorable recording agent on the sheet in a case in which the image is detected by the sensor.

4. The image forming apparatus according to claim 2, wherein
the controller controls the printer to carry out the printing with the non-decolorable recording agent on the sheet in a case in which the image is detected by the sensor.

5. The image forming apparatus according to claim 1, wherein
the controller enables a display section to display a display for prompting the printing with the decolorable recording agent in a case in which the execution of the printing with the non-decolorable recording agent is instructed by a user and in a case in which the image formed with the non-decolorable recording agent or decolorable recording agent is detected by the sensor.

6. The image forming apparatus according to claim 5, wherein
the controller controls the printer to carry out the printing with the decolorable recording agent with the non-decolorable recording agent in a case in which the executing of the printing with the decolorable recording agent is instructed from the user through the display.

7. An image forming method, comprising:
detecting on a sheet an image with a decolorable recording agent comprising a coloring material to be decolored from the sheet;
carrying out a printing operation of an image formed with the decolorable recording agent and a printing operation of an image formed with a non-decolorable recording agent comprising a coloring material that is not decolored; and
controlling execution of the printing operation with the decolorable recording agent on the sheet in a case in which the image is detected.

8. The image forming method according to claim 7, wherein
the printing operation prints the image in a predetermined area of the sheet in a case in which the printing with the decolorable recording agent is carried out.

9. The image forming method according to claim 7, wherein
controlling carrying out the printing operation with the non-decolorable recording agent on the sheet in a case in which the image is detected.

10. The image forming method according to claim 8, wherein
controlling carrying out the printing operation with the non-decolorable recording agent on the sheet in a case in which the image is detected.

11. The image forming method according to claim 7, wherein
displaying a prompt to carry out the printing operation with the decolorable recording agent in a case in which printing with the non-decolorable recording agent is instructed by a user and in a case in which the image is detected.

12. The image forming method according to claim 11, wherein
controlling carrying out the printing operation with the decolorable recording agent from the printing operation with the non-decolorable recording agent in a case in which printing with the decolorable recording agent is instructed from the user.
